(19) United States
(12) Patent Application Publication
(10) Pub. No.: US 2026/0024018 A1
(43) Pub. Date: Jan. 22, 2026

(54) RECONFIGURABLE ARTIFICIAL INTELLIGENCE ECOSYSTEM

(71) Applicant: City University of Hong Kong, Hong Kong (HK)

(72) Inventors: Dapeng WU, Hong Kong (HK); Shiqi WANG, Hong Kong (HK); Peilin CHEN, Hong Kong (HK)

(21) Appl. No.: 19/270,514

(22) Filed: Jul. 16, 2025

Related U.S. Application Data
(60) Provisional application No. 63/671,787, filed on Jul. 16, 2024.

(51) Int. Cl. G06N 20/00

(52) U.S. Cl. CPC G06N 20/00

(57) ABSTRACT

A reconfigurable artificial intelligence (AI) ecosystem is disclosed. The ecosystem comprises: machine learning-based edge devices, a cloud-based operating system, and a modular service platform. The cloud operating system communicates with edge devices and the modular service platform to manage service delivery. Upon receiving a mission request from a subscriber device, the ecosystem selects appropriate edge models, generates corresponding machine learning edge modules, and deploys them to the edge devices. The edge devices then collect mission-specific data, fine-tune the deployed modules locally, and use the refined models to deliver responsive and adaptive services. The ecosystem adopts an open architecture enabling dynamic, on-demand AI service generation and deployment across distributed environments.

### CROSS-REFERENCE TO RELATED APPLICATIONS

The present application claims priority from the U.S. Provisional Patent Application No. 63/671,787 filed on 16 Jul. 2024, and the disclosure of which is incorporated herein by reference in its entirety.

### FIELD OF THE INVENTION

This invention generally relates to artificial intelligence (AI) technologies, and specifically related to a green, reconfigurable AI ecosystem having an open architecture to enable computing hardware to provide mission-oriented AI services.

### BACKGROUND OF THE INVENTION

Contemporary artificial intelligence (AI) systems are predominantly built with a closed architecture design. This means that their hardware and software components are tightly integrated and proprietary, making them incompatible with components developed by third-party manufacturers or developers. Such a design approach significantly limits the modularity and flexibility of the system. In practice, these AI systems function much like a “black box”—their internal workings are opaque to users, and modifications or customizations are either extremely difficult or outright impossible. As a result, end-users are restricted to the capabilities and features predefined, with little to no room for personalization, extension, or innovation based on evolving needs.

This rigidity poses a substantial limitation in sectors where mission objectives are dynamic and user-specific, such as healthcare applications. In many instances, a user,—such as healthcare provider, may require a new functionality or service tailored to a particular patient population or use case. However, within the confines of a closed AI architecture, satisfying this demand would necessitate the procurement of an entirely new hardware/software system. This leads to resource redundancy, increased costs, and elevated electronic waste—an undesirable outcome in an era increasingly conscious of sustainability and environmental impact.

The problem is further exacerbated by the proliferation of wearable devices and the growing interest in mission-oriented AI services. Wearable technology, such as smartwatches, fitness trackers, and medical monitoring devices, generates vast volumes of health-related data in real time. The ability to utilize this data effectively requires AI systems that are adaptable, upgradable, and capable of continuous learning and adjustment. However, the closed nature of current AI architectures restricts the seamless integration of such data and limits the system's ability to evolve in response to new inputs or mission goals.

Therefore, there is pressing need for green computing solutions that not only address the technical constraints of current systems but also prioritize adaptability, interoperability, and operational autonomy. Green computing solutions refer to design and deployment of systems that are energy-efficient, sustainable, and capable of long-term operation without frequent human intervention or system overhauls. It also requires the development of open, modular architectures that allow hardware and software components from diverse vendors to be integrated and function cohesively.

Moreover, it is important to recognize that the many existing AI-enabled services in healthcare still heavily relies on human expertise and labor. For example, in patient care settings, nurses are essential for interpreting data, making decisions, and taking action based on AI-generated insights. While this human-in-the-loop approach ensures safety and personalization, it also imposes a significant burden in terms of labor costs and resource allocation. In high-demand environments, this can lead to staff burnout and inefficiencies, further emphasizing the need for AI systems that can operate with greater autonomy and intelligence derived from the system itself rather than external human input. The transition from closed, monolithic architectures to open, flexible, and sustainable systems is not just a technological necessity but a strategic imperative for the future of mission-oriented applications such as healthcare.

### SUMMARY OF THE INVENTION

One objective of the present invention is to provide a practical AI ecosystem having an open architecture reconfigurable for various real-world scenarios, enabling efficient and reliable delivery of services such as healthcare monitoring. User do not need to purchase new hardware for change of functionality. The AI ecosystem can mitigate environmental pollution resulting from the disposal of non-recyclable components in old electronic devices, and reduces carbon emission due to reduction in manufacturing new hardware, benefiting users in various scenarios.

In accordance with one aspect of the present invention, a reconfigurable artificial intelligence ecosystem is provided. The ecosystem comprises: one or more machine learning-based edge devices; a modular service platform comprising one or more artificial intelligence-based modules; a cloud operating system in communication with the one or more edge devices and the modular service platform. The cloud operating system includes one or more processors and a memory in communication with the one or more processors and storing instructions that, when executed by the one or more processors, configure the modular service platform to: receive a mission request from a subscriber device; select one or more edge models based on the mission request; generating one or more machine learning edge modules based on the one or more selected edge models respectively; and transmit the one or more generated machine learning edge modules to the one or more machine learning-based edge devices. The one or more edge devices are configured to: collect data associated with the mission request; fine-tune the one or more edge modules using the collected data; and use the one or more fine-tuned edge modules to deliver service in response to the mission request.

Preferably, the modular service platform comprises a large language model module configured to analyse the mission request to obtain a parsed mission request.

Preferably, the large language model module is further configured to convert the parsed mission request into one or more service creation subtasks and one or more service deployment subtasks.

Preferably, the large language model module is further configured to execute the one or more service creation subtasks and the one or more service deployment subtasks.

Preferably, the one or more service creation subtasks include at least one task to construct an event dictionary associated with the mission request.

Preferably, the one or more service deployment subtasks include: at least one task to design an event detection algorithm based on the constructed event dictionary; at least one task to select the one or more edge models based on the designed event detection algorithm; and at least one task to generate the one or more machine learning edge modules based on the selected edge models respectively.

Preferably, each of the one or more machine learning-based edge devices includes one or more sensors for collecting physiological and environmental data associated with the mission request.

Preferably, the one or more sensors include at least one temperature sensor, at least one camera, at least one blood pressure meter, and at least one pulse oximeter.

Preferably, the one or more machine learning edge modules are fine-tuned to receive physiological and environmental data from the one or more sensors; autonomously detect events relevant to the mission request; and transmit an alert together with the detected event to the subscriber device.

Preferably, the one or more machine learning edge modules are operated with: at least one central processing unit; at least one graphical processing unit; or at least one advanced reduced instruction set computer machine.

The provided AI ecosystem applies green computing to deliver adaptive, pervasive services that respond to diverse user needs and environmental factors. It can integrate seamlessly with various wearable devices, supporting a sustainable model that eliminates frequent hardware upgrades. The system operates autonomously, handling event dictionary construction, model selection, code generation, event description, and pre-training. Unlike conventional systems limited to predefined tasks, the provided AI ecosystem dynamically adapts to user intentions (e.g., switching between childcare and senior care) without requiring hardware changes, offering flexibility, convenience, and cost savings.

Powered by a machine learning service platform, the system easily scales on public cloud infrastructure to process larger datasets and complex tasks. Its green design reduces electronic waste by enabling existing hardware to support new functions, minimizing environmental impact. Event description generation and continuous learning allow transmission of only essential data, reducing deployment volume and enhancing user privacy. Continuous, targeted data capture supports effective preventive measures by identifying potential issues before they escalate.

### BRIEF DESCRIPTION OF DRAWINGS

Embodiments of the invention are described in more details hereinafter with reference to the drawings, in which:

FIG. 1 shows a schematic block diagram of an open architecture-based AI ecosystem in accordance with one embodiment of the present invention.

FIG. 2 shows an exemplary process flow of the ecosystem performing AI service creation, service deployment, and service execution in accordance with one embodiment of the present invention.

### DETAILED DESCRIPTION

In the following description, details of the present invention are set forth as preferred embodiments. It will be apparent to those skilled in the art that modifications, including additions and/or substitutions may be made without departing from the scope and spirit of the invention. Specific details may be omitted so as not to obscure the invention; however, the disclosure is written to enable one skilled in the art to practice the teachings herein without undue experimentation.

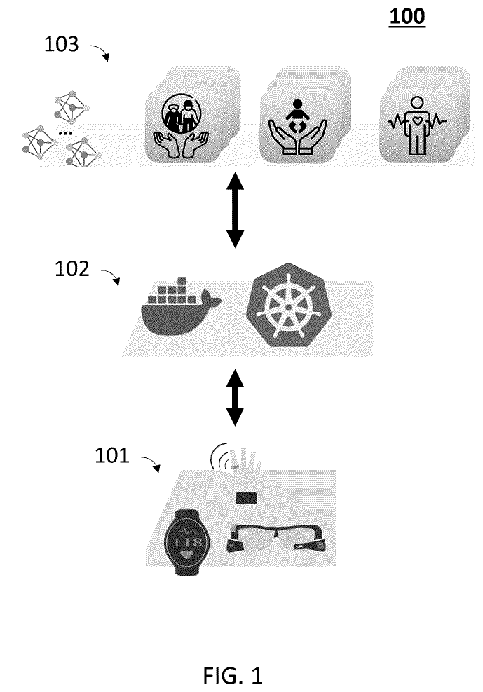

FIG. 1 illustrates a schematic block diagram of an open architecture-based AI ecosystem 100 in accordance with one embodiment of the present invention. The AI ecosystem 100 consists of three tiers: a first tier including one or more machine learning-based edge devices 101; a second tier including a cloud operating system (OS) 102 for operating and managing the one or more edge devices; and a third tier including a modular service platform 103 comprising one or more artificial intelligence (AI) modules operating on top of the cloud OS to facilitate easy portability and efficient scalability.

The cloud operating system 102 includes one or more processors and a memory in communication with the one or more processors and storing instructions that, when executed by the one or more processors, configure the service platform 103 to: receive a mission request from a subscriber device; select one or more edge models based on the mission request; generating one or more machine learning edge modules based on the one or more selected edge models respectively; and transmit the one or more generated machine learning edge modules to the one or more machine learning-based edge devices.

The one or more edge devices 101 are configured to: collect data associated with the mission request; fine-tune the one or more edge modules using the collected data; and use the one or more fine-tuned edge modules to deliver service in response to the mission request.

The one or more AI modules in the service platform may be trained to provide artificial intelligence services such as senior care, child care, patient care, and security surveillance. The edge devices may be equipped with any type of sensors, including but not limited to temperature sensors, image sensors (cameras), blood pressure meters, pulse oximeters. The edge devices also include any type of computing hardware for execution of the machine learning modules. The computing hardware may include, such as but not limited to, central processing units (CPUs), graphics processing units (GPUs), and advanced reduced instruction set computer (RISC) machines (e.g., ARMs).

The AI ecosystem 100 has an open architecture that allows any of its hardware/software component to be replaced by third party components. Under the open architecture, if a user wants a new AI functionality, the user may reuse the old hardware and reconfigure its functionality to serve the new demand, thereby saving the cost of purchasing new hardware. The hardware system is equipped with a variety of data acquisition devices capable of capturing multiple modalities of data. It can dynamically reconfigure its functionalities to support different tasks, thereby enabling adaptability across diverse application scenarios.

The AI ecosystem emerges as a pioneering solution, leveraging green computing principles to offer adaptable, pervasive computing services that respond dynamically to user needs and environmental conditions. The provided AI ecosystem is engineered to seamlessly integrate with heterogeneous wearable devices, ensuring a sustainable computational model that negates the need for frequent hardware changes. This design philosophy not only achieves seamless switching between senior care and patient care upon users' request but also aligns with the evolving computational demands of various mission-oriented services.

The system's architecture is built to support pervasive computing services, capable of adapting to diverse environments, from indoor spaces such as living rooms and bedrooms to outdoor settings. The versatility of AI ecosystem is evident in its capacity to offer reliable computing services under varying environmental conditions and user requirements.

The system is particularly adept at providing continuous, real-time services in critical areas such as patient care. In one embodiment, the ecosystem is integrated in a ventilator system to deliver supportive service of patient monitoring with unwavering reliability. The ventilator system distinguishes itself by offering different service levels, from basic status updates (nurse-level services) to comprehensive analysis and diagnostics (doctor-level services), facilitated through the integration of multiple sensing modalities.

Moreover, the AI ecosystem achieves intelligent service creation and deployment in a self-organized way, which enables hardware to provide services autonomously. Specifically, the autonomous service creation and deployment are achieved by automatic event dictionary construction, model selection, code generation, and pre-training.

First, a large language model (LLM) module will be leveraged to construct a dictionary of events that are relevant to the user's requested mission, e.g., if the mission is senior care, relevant events include blood sugar spikes and heart rate abnormalities. Then a model will be selected from a library of models and codes for detecting the events in the dictionary will be automatically generated. The system will also automatically search for relevant datasets for pre-training the selected model. Then the pre-trained model will be deployed in the sensors as a foundation model. The sensors will further fine-tune the foundation model using their local datasets. It is worth mentioning that these stages are executed by the provided AI ecosystem in a self-organized way without human intervention, which makes sure users' various requests can be quickly served with intelligent service creation and deployment in an AAA manner.

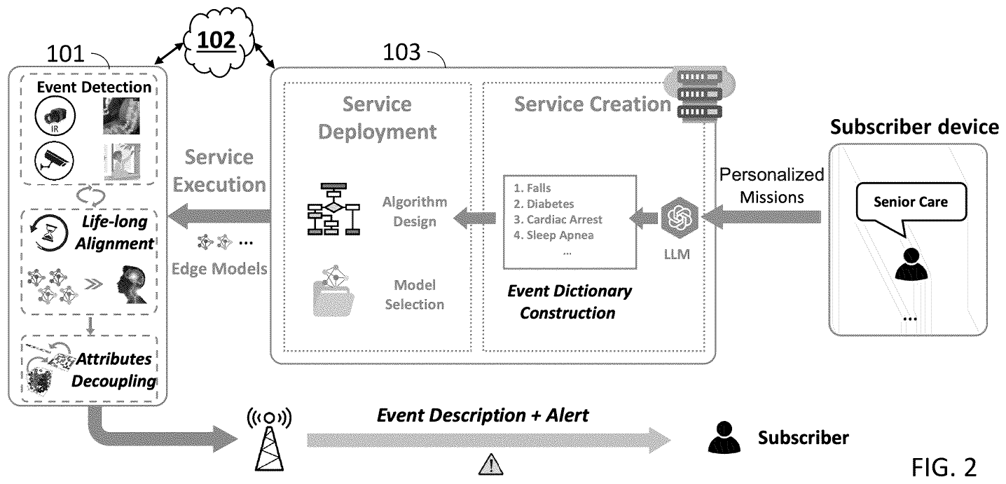

FIG. 2 shows an exemplary process flow of the ecosystem performing AI service creation, service deployment, and service execution for a healthcare mission request in accordance with one embodiment of the present invention.

First, a subscriber sends a request for a personalized mission, such as senior care, through a subscriber device to the service platform. The request is then automatically processed by an AI-based parser module within the service platform, which interprets the input and extracts relevant parameters. A subsequent planner module transforms the interpreted request into a series of executable subtasks related to service creation and deployment. These subtasks may include, but are not limited to, the construction of a mission-specific event dictionary and the design of corresponding event detection algorithms. For instance, in a senior care application, the event dictionary may define critical events such as accidents (e.g., falls) and medical conditions (e.g., diabetes, cardiac arrest, and sleep apnoea), enabling the system to monitor and respond to such events in a timely and automated manner.

The design of the event detection algorithm includes selecting an appropriate computational model and generating executable code through an automated process. Once the model and corresponding code are generated, they are transmitted to the edge devices (also known as edge devices or information providers) for localized execution. The edge devices are then configured to perform the received computational model and executable codes to conduct real-time monitoring and event detection, thereby enabling distributed and responsive healthcare service delivery.

The edge devices may include an infrared temperature sensor for monitoring a senior's body temperature and a camera for capturing real-time video footage. The edge devices may further include healthcare processors configured to analyze both the temperature data and video stream using the models and executable program code received from the service platform. Based on the senior's historical health database, the healthcare processors perform life-long alignment analysis to detect deviations or patterns relevant to the individual's health profile; execute attribute decoupling to isolate relevant indicators; and generate a structured event description reflecting the analysis outcome. The generated event description, along with a corresponding alert, is then transmitted to the subscriber device for timely response and intervention.

The functional units and modules of the reconfigurable AI ecosystem in accordance with the embodiments disclosed herein may be implemented using computing devices, computer processors, or electronic circuitries including but not limited to application specific integrated circuits (ASIC), field programmable gate arrays (FPGA), microcontrollers, and other programmable logic devices configured or programmed according to the teachings of the present disclosure. Computer instructions or software codes running in the computing devices, computer processors, or programmable logic devices can readily be prepared by practitioners skilled in the software or electronic art based on the teachings of the present disclosure.

All or portions of the methods in accordance to the embodiments may be executed in one or more computing devices including server computers, personal computers, laptop computers, mobile computing devices such as smartphones and tablet computers.

The embodiments may include computer storage media, transient and non-transient memory devices having computer instructions or software codes stored therein, which can be used to program or configure the computing devices, computer processors, or electronic circuitries to perform any of the processes of the present invention. The storage media, transient and non-transient memory devices can include, but are not limited to, floppy disks, optical discs, Blu-ray Disc, DVD, CD-ROMs, and magneto-optical disks, ROMs, RAMs, flash memory devices, or any type of media or devices suitable for storing instructions, codes, and/or data.

Each of the functional units and modules in accordance with various embodiments also may be implemented in distributed computing environments and/or Cloud computing environments, wherein the whole or portions of machine instructions are executed in distributed fashion by one or more processing devices interconnected by a communication network, such as an intranet, Wide Area Network (WAN), Local Area Network (LAN), the Internet, and other forms of data transmission medium.

While the present disclosure has been described and illustrated with reference to specific embodiments thereof, these descriptions and illustrations are not limiting. The illustrations may not necessarily be drawn to scale. There may be distinctions between the illustrations in the present disclosure and the actual apparatus due to manufacturing processes and tolerances. There may be other embodiments of the present disclosure which are not specifically illustrated. Modifications may be made to adapt a particular situation, material, composition of matter, method, or process to the objective and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations.

What is claimed is:

1. A reconfigurable artificial intelligence ecosystem, comprising:
one or more machine learning-based edge devices;
a modular service platform comprising one or more artificial intelligence-based modules;
a cloud operating system in communication with the one or more edge devices and the modular service platform;
wherein the cloud operating system includes one or more processors and a memory in communication with the one or more processors and storing instructions that, when executed by the one or more processors, configure the modular service platform to:
receive a mission request from a subscriber device;
select one or more edge models based on the mission request;
generating one or more machine learning edge modules based on the one or more selected edge models respectively; and
transmit the one or more generated machine learning edge modules to the one or more machine learning-based edge devices, respectively; and
wherein the one or more edge devices are configured to:
collect data associated with the mission request;
fine-tune the one or more edge modules using the collected data; and
use the one or more fine-tuned edge modules to deliver service in response to the mission request.

2. The reconfigurable artificial intelligence ecosystem of claim 1, wherein the modular service platform comprises a large language model module configured to analyse the mission request to obtain a parsed mission request.

3. The reconfigurable artificial intelligence ecosystem of claim 2, wherein the large language model module is further configured to convert the parsed mission request into one or more service creation subtasks and one or more service deployment subtasks.

4. The reconfigurable artificial intelligence ecosystem of claim 3, wherein the large language model module is further configured to execute the one or more service creation subtasks and the one or more service deployment subtasks.

5. The reconfigurable artificial intelligence ecosystem of claim 4, wherein the one or more service creation subtasks include at least one task to construct an event dictionary associated with the mission request.

6. The reconfigurable artificial intelligence ecosystem of claim 5, wherein the one or more service deployment subtasks include:
at least one task to design an event detection algorithm based on the constructed event dictionary;
at least one task to select the one or more edge models based on the designed event detection algorithm; and
at least one task to generate the one or more machine learning edge modules based on the selected one or more edge models respectively.

7. The reconfigurable artificial intelligence ecosystem of claim 1, wherein each of the one or more machine learning-based edge devices includes one or more sensors for collecting physiological and environmental data associated with the mission request.

8. The reconfigurable artificial intelligence ecosystem of claim 7, wherein the one or more sensors include at least one temperature sensor, at least one camera, at least one blood pressure meter, and at least one pulse oximeter.

9. The reconfigurable artificial intelligence ecosystem of claim 7, wherein the one or more machine learning edge modules are fine-tuned to:
receive physiological and environmental data from the one or more sensors;
autonomously detect events relevant to the mission request; and
transmit the detected event together with an alert to the subscriber device.

10. The reconfigurable artificial intelligence ecosystem of claim 6, wherein the one or more machine learning edge modules are operated with at least one central processing unit, at least one graphical processing unit, and/or at least one advanced reduced instruction set computer machine.
